(19) United States
(12) Patent Application Publication
(10) Pub. No.: US 2008/0007936 A1
(43) Pub. Date: Jan. 10, 2008

(54) Organic illumination source and method for controlled illumination

(76) Inventors: Jie Liu, Niskayuna, NY (US); Svetlana Rogojevic, Niskayuna, NY (US); Joseph John Shiang, Niskayuna, NY (US); Donald Franklin Foust, Glenville, NY (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/480,734

(22) Filed: Jul. 5, 2006

(51) Int. Cl. F21V 9/16

(52) U.S. Cl. 362/84

(57) ABSTRACT

An illumination source including a three-dimensional structure having at least one interior surface including at least one OLED panel which defines and encloses a port for outlet of light produced by the at least one OLED panel and having a surface area greater than area of the port, is disclosed. A method for tuning color and/or intensity of the light output of an illumination source is also disclosed.

### STATEMENT REGARDING FEDERALLY SPONSORED RESEARCH & DEVELOPMENT

This invention was made with Government support under contract number 70NANB3H3030 awarded by NIST. The Government has certain rights in the invention.

### BACKGROUND

The invention generally relates to organic illumination sources. The invention particularly relates to organic illumination sources with controllable illumination.

For various lighting applications it is desirable to have illumination sources with controllable illumination. In such cases, organic light emitting devices (OLEDs) can be effective alternatives to conventional illumination sources.

Prior approaches to providing specific colored OLED illumination sources include using stacked OLEDs with a plurality of color emitting panels or flat panel displays with arrays of colored lights, such as red, blue, and green emitting OLEDs. Such approaches may fall short of providing the required light intensity and color mixing required for a desired illumination effect.

It would therefore be highly desirable to provide an area illumination source in which the illumination source can be tuned to provide a desired intensity, chromaticity, and color rendition index.

### BRIEF DESCRIPTION

In one embodiment of the present invention is an illumination source including a three-dimensional structure including at least one interior surface comprising at least one OLED panel, said at least one interior surface defining and enclosing a port for outlet of light produced by said at least one OLED panel, and having surface area greater than area of the port.

In another embodiment of the present invention, is an illumination source including a three-dimensional curved structure, including at least one interior curved surface comprising a plurality of OLED panels, said at least one interior curved surface defining and enclosing a port for outlet of light produced by said plurality of OLED panel, and having surface area greater than area of the port.

In still another embodiment of the present invention, a method for tuning color and/or intensity of the light output of an illumination source including at least one OLED panel, said method including providing an illumination source comprising a three dimensional structure comprising at least one interior surface comprising said at least one OLED panel, said at least one surface defining and enclosing a port for outlet of light produced by said at least one OLED panel, and having surface area greater than area of the port; and providing electrical power to said at least one OLED panel, whereby color and/or intensity of the light output of the illumination source is tuned.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic representation of an illumination source in one embodiment of the present invention.

FIG. 2 is a schematic cross-sectional view of an illumination source in one embodiment of the present.

FIG. 3 is a schematic bottom view of an illumination source in one embodiment of the present invention.

FIG. 4 is a schematic bottom view of an illumination source in one embodiment of the present invention.

FIG. 5 is a schematic cross-sectional view of an illumination source including a light management panel in one embodiment of the present invention.

FIG. 6 schematic cross-sectional view of an illumination source including a barrier panel in one embodiment of the present invention.

FIG. 7 schematic cross-sectional view of an illumination source including a light emitting panel in one embodiment of the present invention.

FIG. 8 is a schematic view of an illumination source including a pattern-creating panel in one embodiment of the present invention.

FIG. 9 is a schematic representation of an OLED panel in one embodiment of the present invention.

FIG. 10 is a schematic representation of an OLED panel in one embodiment of the present invention.

FIG. 11 is a schematic representation of an illumination source in one embodiment of the present invention.

FIG. 12 is a schematic representation of an illumination source in one embodiment of the present invention.

FIG. 13 is a schematic representation of an illumination source in one embodiment of the present invention.

FIG. 14 is a schematic representation of an illumination source in one embodiment of the present invention.

### DETAILED DESCRIPTION

Embodiments of the present invention relate to organic illumination sources and methods for controlled illumination. As used herein, the term “organic illumination source” refers to an organic light emitting device (OLED) illumination source. As used herein, the term “OLED” refers to devices including organic light emitting materials generally, and includes but is not limited to organic light emitting diodes. As used herein, the term “OLED element” refers to the basic light-producing unit of the area illumination sources of the present invention, comprising at least two electrodes with a light-emitting organic material disposed between the two electrodes. As used herein, the term “OLED panel” refers to a light-producing unit including at least one OLED element.

As used herein, the term “controlled illumination” refers to control of intensity, chromaticity, and/or color rendition index (CRI) of the illumination source.

As will be appreciated by one skilled in the art, an OLED element typically includes at least one organic layer, typically an electroluminescent layer, sandwiched between two electrodes. Upon application of an appropriate voltage to the OLED, the injected positive and negative charges recombine in the electroluminescent layers to produce light. The OLED element may include additional layers such as hole transport layers, hole injection layers, electron transport layers, electron injection layers, photoabsorption layers, cathode layers, anode layers or any combination thereof. OLED elements of the present invention may include other layers such as, but not limited to, one or more of a substrate layer, an abrasion resistant layer, an adhesion layer, a chemically resistant layer, a photoluminescent layer, a radiation-absorbing layer, a radiation reflective layer, a barrier layer, a planarizing layer, optical diffusing layer, and combinations thereof.

In one embodiment the present invention relates to an illumination source including a three-dimensional structure. The structure includes at least one interior surface having at least one OLED panel. The interior surface defines and encloses a port for outlet of light produced by the at least one OLED panel and has a surface area greater than area of the port. In a further embodiment, the at least one interior surface has a light emitting area greater than the area of the port. Advantageously, the illumination source in one embodiment of the present invention is capable of producing greater light flux through the port compared to a two dimensional planar illumination source with a light emitting area equal to the area of the port. Further more, in one embodiment of the present invention, if two or more OLED panels emitting at different wavelengths are present, then beneficially, the illumination source provides better color mixing than an array of OLED panels emitting at different wavelengths on a planar illumination source. Advantageously, in a three dimensional arrangement of the OLED panels, certain arrangements of two or more OLED panels emitting at different wavelengths can provided enhanced color mixing as proposed in the embodiments of the present invention.

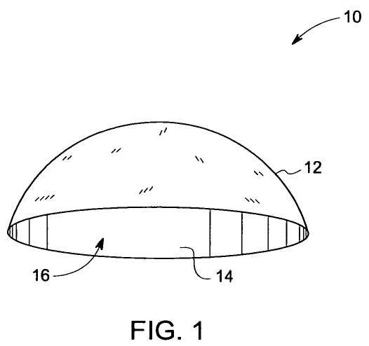

In the embodiment shown in FIG. 1, an illumination source 10 includes three-dimensional structure 12 having an interior curved surface 14. The hemispherical structure shown in FIG. 1 is a non-limiting example of a three dimensional structure according to present invention. Curved surface 14 defines port 16 through which light emerges.

In one embodiment, the edges of the port may lie in a single plane. In another embodiment, the edges of the port do not lie on a single plane. In some embodiments of the present invention, the edges of the port may be regular or irregular such as being jagged.

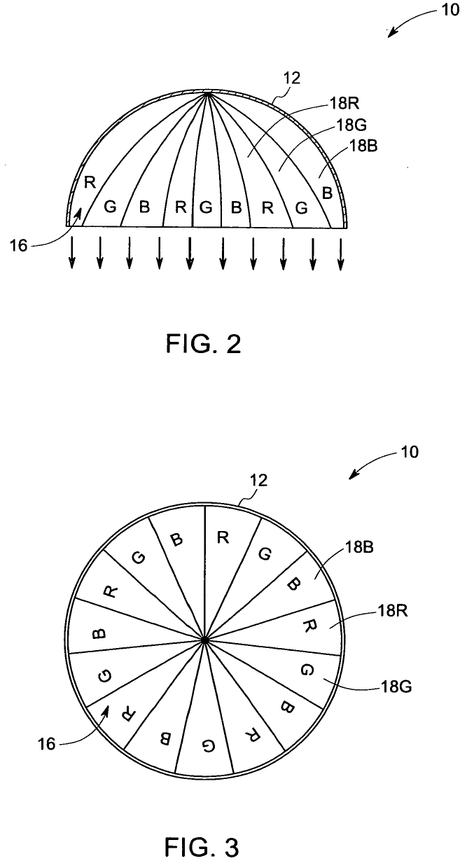

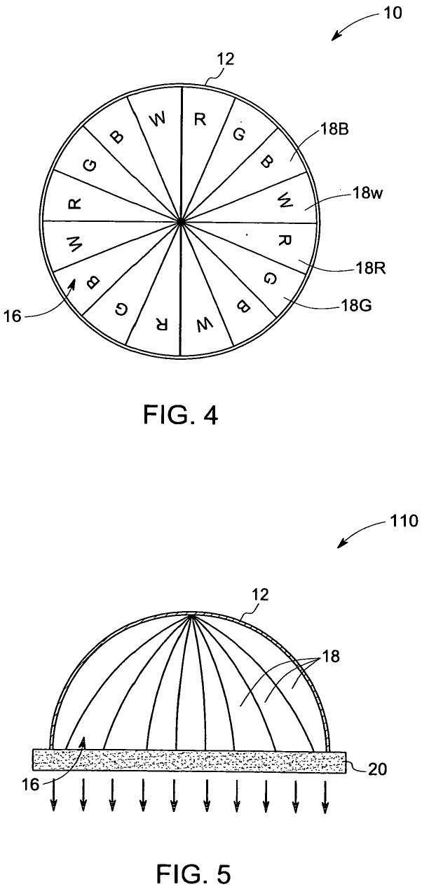

In the cross-sectional view of illumination source 10 shown in FIG. 2, interior curved surface 14 includes OLED panels 18R, 18G, and 18B. In this embodiment, OLED panels 18R, 18B, and 18G, are configured to emit light in the red (R), blue (B), and green (G) region of the visible spectrum, respectively. FIG. 3 is a bottom view of the illumination source looking into the port showing the arrangement of the red (R) 18R, blue (B) 18B, and green (G) 18G OLED panels in the illumination source 10. In a further embodiment, the interior surface also includes an OLED panel capable of emitting light of a fourth color. In the illustrated embodiment in FIG.4, the OLED panels 18 include white (W) 18W light emitting panels along with red (R) 18R, blue (B) 18B, and green (G) 18G OLED panels. In this illustrated embodiment, the OLED panel is non-planar, specifically curved, although in other embodiments, the OLED panels may be planar without any curvature.

In some embodiment of the present invention, the OLED panels in the illumination source are physically modular. As used herein, the term “physically modular” means that the panels can be removed or replaced without dismantling or removing other panels. In a further embodiment, the panels are mounted using quick release connectors.

In some embodiments of the present invention, the OLED panels in the illumination source are “electrically modular”. As used herein, the term “electrically modular” refers to an attribute of a panel whereby the panel can be independently electrically controlled. For example, panels disposed within the illumination source of the present invention are “electrically modular” in that the voltage applied to each individual panel may be varied independently. In one embodiment, two or more OLED panels may be connected in series. In another embodiment, the two or more OLED panels may be connected in parallel.

Illumination source 110, illustrated in FIG. 5 includes a light management element 20, such as a diffuser element, mounted across the port to diffuse the light emerging from the one or more OLED panels. In a non-limiting example, the diffuser element is formed through texturing the surface of a transparent material to make a surface diffuser. Other suitable examples of surface diffusers include transparent material having one or both surfaces textured with positive or negative lens structures and Fresnel lens structures and any combination of such structures. Other waveguiding and light bending elements can also used. In one embodiment, the light management film is a curved panel.

In another embodiment, a light management element, such as a scattering element, is mounted across the port 16 to scatter the light emerging from the one or more OLED panels. The scattering element may be formed by suspending particles with a high index within a lower index medium to make a volumetric scattering system.

The light management element may also be a photoluminescent (PL) element. The photoluminescent element includes materials that absorb some of the incident radiation and reemit at a different wavelength. In one embodiment, the PL materials include materials absorb at least a portion of shorter-wavelength light, such as in the blue region, emitted by the OLED elements and reemit in the longer-wavelength such as in the green and/or red region of the visible spectrum. For example, organic PL materials that exhibit absorption maxima in the blue portion of the spectrum exhibit emission in the green portion of the spectrum. Thus, the unabsorbed portion of the blue light emitted by the OLED elements are mixed with the green and red light emitted by the PL material or materials to produce white light. The PL materials can be organic, inorganic, or a mixture of organic and inorganic phosphors.

Some non-limiting examples of suitable organic PL materials, azo dyes, anthraquinone dyes, nitrodipheylamine dyes, iron (II) complexes of 1-nitroso-2-naphthol and 6-sulphol-1-nitroso-2-naphthol, as disclosed in P. F. Gordon and P. Gregory, “Organic Chemistry in Colour,” Springer-Verlag, Berlin pp. 99-101, 105-106, 126, 180, 253-255, and 257 (1983). Other organic PL materials are coumarin and xanthene dyes. PL materials may also include inorganic phosphors. Suitable phosphors based on YAG doped with more than one type of rare earth ions, such as cerium-doped yittrium aluminum oxide Y₃Al₅O₁₂ garnet (“YAG:Ce”). Green-emitting phosphors include but are not limited to Ca₈M_{g}(SiO₄)₄Cl₂:Eu²⁺, Mn²⁺; GdBO₃:Ce³⁺, Tb³⁺; CeMgAl₁₁O₁₉: Tb³⁺; Y₂SiO₅:Ce³⁺, Tb³⁺; and BaMg₂Al₁₆O₂₇:Eu²⁺,Mn²⁺. Red-emitting phosphors phosphors include but are not limited to Y₂O₃:Bl³⁺,Eu³⁺; Sr₂P₂O₇:Eu²⁺,Mn²⁺; SrMgP₂O₇:Eu²⁺,Mn²⁺; (Y,Gd)(V,B)O₄:Eu³⁺; and 3.5 MgO.0.5MgF₂,GeO₂:Mn⁴⁺ (magnesium fluorogermanate). Blue-emitting phosphors include but are not limited to BaMg₂Al₁₆O₂₇:Eu²⁺; Sr₅(PO₄)₁₀Cl₂:Eu²⁺; (Ba,Ca,Sr)₅(PO₄)₁₀(Cl,F)₂:E²⁺, (Ca,Ba,Sr)(Al,Ga)₂S₄:Eu²⁺. Yellow-emitting phosphors include but are not limited to (Ba,Ca,Sr)₅(PO⁴)₁₀(Cl,F)₂:Eu²⁺,Mn²⁺.

In a non-limiting example, the phosphor particles are dispersed in a film-forming polymeric material, such as polyacrylates, substantially transparent silicone or epoxy. A phosphor composition of less than about 30 percent by volume of the mixture of polymeric material and phosphor is used. A solvent is added into the mixture to adjust the viscosity of the film-forming material to a desired level. In a non-limiting example, freestanding tapes with variable optical scattering can be prepared by mixing a known weight of non-visible light absorbing particles with 10 grams of uncured polydimethylsiloxane resin (n=1.41 for the cured film). The two powders suitable for this application are cool white (CW) phosphor (d₅₀=6 μm) (commercially available), and ZrO₂ powder (d₅₀=0.6 μm). The median particle sizes are determined via light scattering. Typical weight loadings are between 0.2%-1.76% for the ZrO₂, and 1%-20% for the CW phosphor particles. The mixture of the film-forming material and phosphor particles is formed into a layer by spray coating, dip coating, printing, or casting on a substrate. Thereafter, the film is removed from the substrate and mounted across the port.

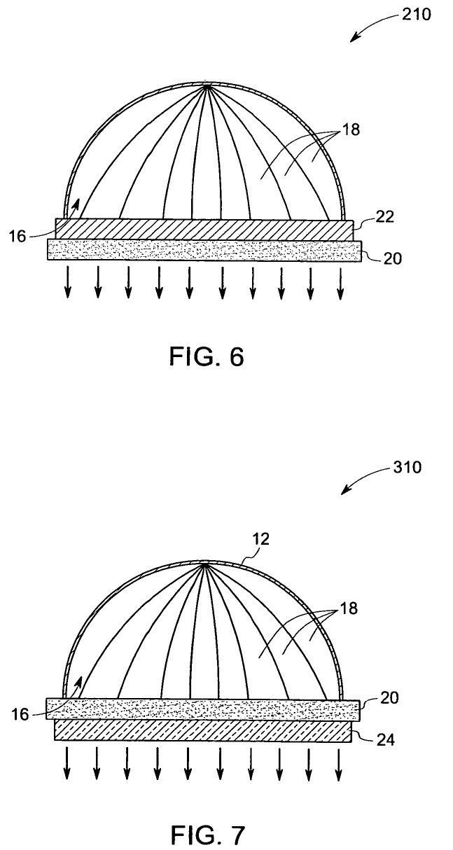

Organic devices are susceptible to attack by reactive species existing in the environment, such as oxygen, water vapor, hydrogen sulfide, SOx, NOx, solvents, etc., leading to deterioration in device performance. In still another embodiment of the present invention, illumination source 210 includes a barrier element 22 mounted across port 16 as shown in FIG. 6. Barrier elements may help protect the OLED panels. In a further embodiment, such barrier elements are engineered to affect light transmission only to a small extent and are useful in extending the device lifetime without degrading the overall device efficiency. In one embodiment, the barrier element is substantially transparent. The term “substantially transparent” means allowing a total transmission of at least about 50 percent, preferably at least about 80 percent, and more preferably at least 90 percent, of light in a selected wavelength range. The selected wavelength range can be in the visible region, the infrared region or the ultraviolet region. In a non-limiting example, the barrier panel limits the penetration of reactive species such as oxygen and water vapor to the organic materials in the OLED panel.

The barrier element may include barrier materials such as, but not limited to, organic, inorganic, hybrid organic-inorganic materials or multilayer organic-inorganic materials or metal foils. Organic barrier materials may comprise carbon, hydrogen, oxygen and optionally, other minor elements, such as sulfur, nitrogen, and silicon. The organic materials may comprise acrylates, epoxies, epoxyamines, xylenes, siloxanes, silicones, etc. Inorganic and ceramic materials typically comprise oxide, nitride, carbide, boride, oxynitride, oxycarbide, or combinations thereof of elements of Groups IIA, IIIA, IVA, VA, VIA, VIIA, IB, and IIB; metals of Groups IIIB, IVB, and VB, and rare-earth metals. For example, silicon carbide can be deposited onto a substrate by recombination of plasmas generated from silane (SiH₄) and an organic material, such as methane or xylene to form a barrier element. In a further example, silicon oxycarbide can be deposited from plasmas generated from organosilicone precursors, such as tetraethoxysilane, hexamethyldisiloxane, hexamethyldisilazane, or octamethylcyclotetrasiloxane.

In another embodiment of the present invention, illumination source 310 includes a substantially transparent light emitting element 24 mounted across the port 16 as shown in FIG. 7. In a non-limiting example, the light-emitting element is a substantially transparent white light-emitting element. In a further embodiment, the white light emitting panel is an organic white light emitting element.

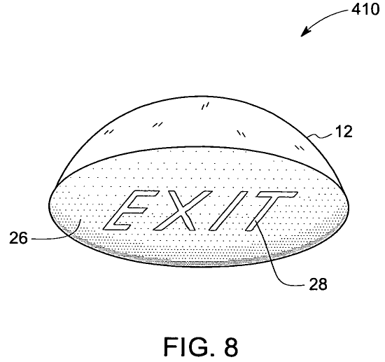

In still another embodiment, a pattern-creating element may be disposed across the port. Non-limiting examples of patterns include signage including letters and numbers, geometrical shapes and patterns with aesthetic features. In one embodiment, the patterns in the pattern-creating element have varying transmissivity. For example, the patterns preferentially transmit or filter light at a certain wavelength or ranges of wavelengths. Different parts of the pattern may transmit or filter light at a wavelength or range of wavelengths. Illumination source 410 shown in FIG. 8, includes a pattern-creating element 26 having text “EXIT” 28 patterned on it. In a non-limiting example, the pattern “EXIT” preferentially transmits light in the red while the rest of the pattern-creating element is opaque.

An element mounted across the port, for example, a barrier element, a light-management element or a pattern-creating element, may be planar without facets or curvature or may be non-planar with facets and/or curvature. In one embodiment, an element mounted across the port is removably coupled to the port.

In a further embodiment of an illumination source of the present invention is a semi-cylindrical or part-cylindrical three dimensional structure (fraction of a full cylindrical structure) with one or more OLED panels mounted on its curved interior surface and with side panels on each curved end of the structure. In one embodiment, the side panels may include one or more OLED panels. In another embodiment, the side panels may include one or more reflective panels.

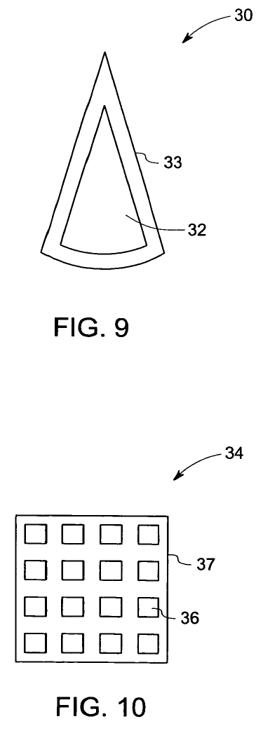

In one embodiment of the present invention, the OLED panel includes one or more OLED elements. FIG. 9 shows an OLED panel 30 that includes OLED element 32 and a mount 33. As used herein, the term “mount” refers to a mechanical support for the OLED element. In an alternative embodiment shown in FIG. 10, OLED panel 34 includes a plurality of OLED elements 36. FIG. 10 shows the OLED panel 34 including a mount 37 supporting the plurality of OLED elements 36. In a further embodiment of the present invention, the mount comprises a reflective material. In a non-limiting example, the reflective material is a metal. In one embodiment of the present invention, at least one surface of the mount is curved. Although the embodiments illustrated in FIG. 9 and FIG. 10 show the OLED elements as being supported on a separate mount, in other embodiments of the present invention (not shown), the OLED panels do not include a separate mount. Instead, are directly secured together to form the three dimensional structure. In one embodiment, the OLED panels are fastened to a frame using retainer pins. Other means of fastening the panels to the frame include, but are not limited to, using double sticky tapes, using double sticky forms, using glue, using position/insertion slots, and using hinges.

The elements on a panel may be individually addressable or electrically connected so that a single pair of electrical connections provide power to each OLED element disposed within a panel. In some embodiments, the OLED element may be a tandem or stacked device capable of emitting at more than one wavelength. In other embodiments, the OLED elements are connected in series. In still other embodiments, the one or more OLED elements are connected in parallel.

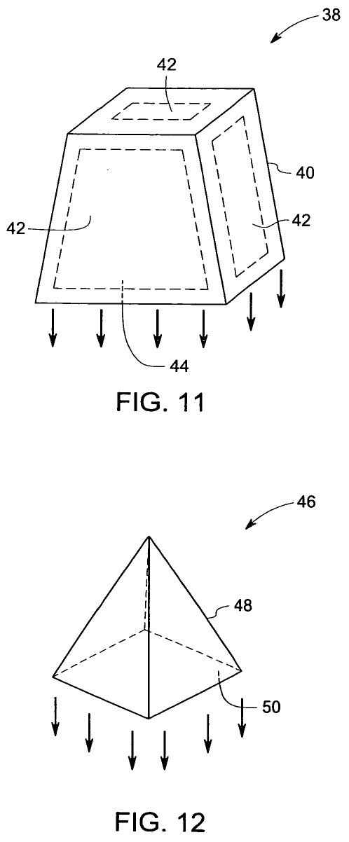

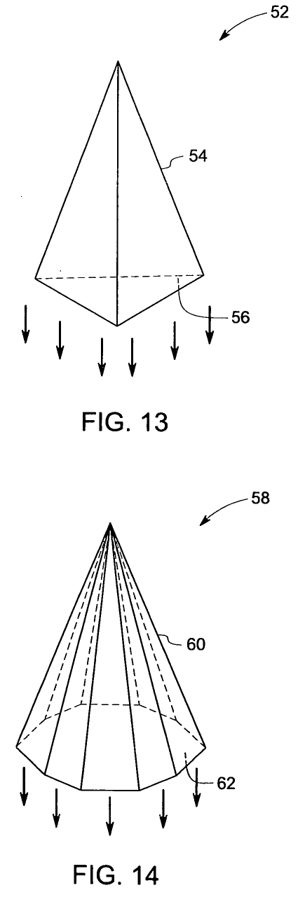

In other embodiments, the three dimensional structure includes multiple interior facets as shown in FIGS. 11 through 14. In FIG. 11, an illumination source 38 includes a three dimensional structure 40 having 5 facets (four side walls and one top cover) which define port 44. OLED panels 42 are mounted on interior surfaces of all facets. In another embodiment shown in FIG. 12, an illumination source 46 includes a tetrahedral three dimensional structure 48 with a port 50 through which the light emerges. In a similar embodiment as shown in FIG. 13, an illumination source 52 includes a pydramidal structure 54 with a port 56. FIG. 14 is an embodiment illustrating an illumination source 58 with a plurality of exterior facets 60 defining a port 62.

In one embodiment of the present invention, the light output of each of at least two OLED panels is independently controllable. The illumination source may further include circuit elements for controlling and delivering electrical power to the one or more OLED panels. In a further embodiment, the illumination source is configured to selectively power one or more OLED panels. One or more OLED elements included in an OLED panel may be further connected to circuit elements capable of controlling the light emission from each of the OLED elements as well. The illumination source may further include circuit elements to supply the required voltage necessary to power the OLED panels. The illumination source may include circuit elements such as AC to DC converters and diodes placed in series, to convert available AC power to the required DC power. In a further embodiment, the illumination source may be directly powered by AC power. Non-limiting examples of other circuit elements which may be present in the illumination source include resistors, varistors, voltage dividers, and capacitors. In one embodiment, the OLED elements are connected together is a series connected OLED architecture.

General principles of series connected OLED architecture and the use of circuit elements for controlling and delivering electrical power to the one or more OLED panels or OLED elements can be more clearly understood by referring to U.S. Pat. No. 7,049,757; U.S. Pat. No. 6,566,808; U.S. Pat. No. 6,800,999; Application (abandoned) having Ser. No. 10/208543 (patent publication number US20020190661A1), filed on Jul. 31, 2002; copending Application having Ser. No. 10/889498 (patent publication number US20040251818A1), filed on Jul. 10, 2004; and copending Application having Ser. No. 11/347089 (patent publication number US20060125410A1), filed on Feb. 03, 2006. It should be noted that with respect to the interpretation and meaning of terms in the present application, in the event of a conflict between this application and any of the above referenced document, the conflict is to be resolved in favor of the definition or interpretation provided by the present application.

In one embodiment of the present invention, the illumination source emission is color tunable. In a non-limiting example, the illumination source produces white light. In one embodiment the white light has a color temperature ranging from about 5500° K. to about 6500° K. As used herein, “color temperature” of an illumination source refers to a temperature of a blackbody source having the closest color match to the illumination source in question. The color match is typically represented and compared on a conventional CIE (Commission International de l'Eclairage) chromaticity diagram. See, for example, “Encyclopedia of Physical Science and Technology”, vol. 7, 230-231 (Robert A. Meyers ed, 1987). Generally, as the color temperature increases, the light appears more blue. As the color temperature decreases, the light appears more red. In another embodiment of the present invention, the illumination source emits white light having a color temperature ranging from about 2800° K. to about 5500° K. In certain embodiments the illumination source emits white light having a color temperature ranging from about 2800° K. to about 3500° K. In some embodiments, the illumination source has a color temperature about 4100° K.

In one embodiment, an illumination source with a color temperature in the range from about 5500° K. to about 6500° K. has a color rendering index ranging from about 60 to about 99. As used herein, color rendering index (CRI) is a measure of the degree of distortion in the apparent colors of a set of standard pigments when measured with the light source in question as opposed to a standard light source. The CRI is determined by calculating the color shift, e.g. quantified as tristimulus values, produced by the light source in question as opposed to the standard light source. Typically, for color temperatures below 5000° K., the standard light source used is a blackbody of the appropriate temperature. For color temperatures greater than 5000° K., sunlight is typically used as the standard light source. Light sources having a relatively continuous output spectrum, such as incandescent lamps, typically have a high CRI, e.g. equal to or near 100. Light sources having a multi-line output spectrum, such as high pressure discharge lamps, typically have a CRI ranging from about 50 to about 90. Fluorescent lamps typically have a CRI greater than about 60.

In a further embodiment, an illumination source with a color temperature in the range from about 5500° K. to about 6500° K. has a color rendering index ranging from about 75 to about 99. In a still further embodiment, an illumination source with a color temperature in the range from about 5500° K. to about 6500° K. has a color rendering index ranging from about 85 to about 99. In still another embodiment, an illumination source with a color temperature in the range from about 2800° K. to about 5500° K. has a color rendering index of at least about 60. In still another embodiment, an illumination source with a color temperature in the range from about 2800° K. to about 5500° K. has a color rendering index of at least about 75. In still another embodiment, an illumination source with a color temperature in the range from about 2800° K. to about 5500° K. has a color rendering index of at least about 85.

In one embodiment, the illumination source is mountable onto a structure. In a non-limiting example, the illumination source is adapted for wall mounting. The illumination source may alternatively be mounted upon the ceiling or be suspended from the ceiling. In an alternative embodiment, the illumination source is free standing.

In another embodiment, the present invention relates to a method for control of color and/or intensity of the light output of an illumination source comprising at least one OLED panel. As used herein, the term “color” refers to chromaticity and/or CRI. The method includes providing an illumination source including a three dimensional structure with at least one interior surface comprising said at least one OLED panel, said at least one surface defining and enclosing a port for outlet of light produced by said at least one OLED panel. The interior surface has a surface area greater than area of the port. The method further includes providing electrical power to said at least one OLED panel, whereby color and/or intensity of the light output of the illumination source is tuned. In a non-limiting example, intensity tuning is achieved by applying identical or varied voltages to the two or more panels. As used herein, the term “tuning” is used to refer to either selecting a value and/or tuning from one value to another. In a further example, the intensity is tuned by varying the voltage level applied to one or more panels. In a non-limiting example, color tuning in an illumination source including a plurality of OLED panels is achieved by selectively powering one or more OLED panels emitting light at the same or varied wavelengths. In a further example, color tuning is achieved by varying the power levels used to power the one or more OLED panels. The method may further include using a diffuser across the port to diffuse light emitted by at least one OLED panel.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An illumination source comprising:
a three-dimensional structure having at least one interior surface comprising at least one OLED panel, said at least one interior surface defining and enclosing a port for outlet of light produced by said at least one OLED panel, and having surface area greater than area of the port.

2. The illumination source of claim 1, wherein the at least one interior surface has a light emitting area greater than the area of the port.

3. The illumnination source of claim 1, wherein the at least one interior surface is a curved surface.

4. The illumination source of claim 1, wherein the three dimensional structure comprises a hemispherical structure.

5. The illumination source of claim 1, wherein the three dimensional structure comprises multiple interior facets.

6. The area illumination source of claim 1, wherein the three dimensional structure comprises a plurality of interior surfaces.

7. The area illumination source of claim 1, wherein said at least one interior surface is curved.

8. The illumination source of claim 1, wherein the illumination source produces a white light having a color temperature ranging from about 5500° K. to about 6500° K.

9. The illumination source of claim 8, wherein the white light has a color rendering index ranging from about 60 to about 99.

10. The illumination source of claim 1, wherein the illumination source produces a white light having a color temperature ranging from about 2800° K. to about 5500° K.

11. The illumination source of claim 10, wherein the white light has a color rendering index of at least 60.

12. The illumination source of claim 1, wherein said at least one interior surface comprises two or more OLED panels selected from OLED panels capable of emitting light of a first color, OLED panels capable of emitting light of a second color, OLED panels capable of emitting light of a third color and OLED panels capable of emitting light of a fourth color.

13. The illumination source of claim 1, further comprising a diffuser element disposed across the port.

14. The illumination source of claim 1, further comprising a scattering element disposed across the port.

15. The illumination source of claim 1, further comprising a barrier element disposed across the port.

16. The illumination source of claim 1, further comprising a photoluminescent element mounted across the port.

17. The illumination source of claim 1, further comprising a pattern-creating element disposed across the port.

18. The illumination source of claim 17, wherein at least a portion of said pattern-creating element transmits light in a desired wavelength or wavelength range.

19. The illumination source of claim 1, further comprising a transparent light emitting element disposed across the port.

20. The illumination source of claim 1, wherein the OLED panel includes a mount.

21. The illumination source of claim 20, wherein at least one surface of the mount is curved.

22. The illumination source of claim 20, wherein the mount is reflective.

23. The illumination source of claim 1, further comprising circuit elements for controlling electrical power to said at least one OLED panel.

24. The illumination source of claim 23, wherein light output of each of at least two OLED panels is independently controllable.

25. An illumination source comprising:
a three-dimensional curved structure, having at least one interior curved surface comprising a plurality of OLED panels, said at least one interior curved surface defining and enclosing a port for outlet of light produced by said plurality of OLED panel, and having surface area greater than area of the port.

26. A method for tuning color and/or intensity of the light output of an illumination source comprising at least one OLED panel, said method comprising:
providing an illumination source comprising a three dimensional structure comprising at least one interior surface comprising said at least one OLED panel, said at least one surface defining and enclosing a port for outlet of light produced by said at least one OLED panel, and having surface area greater than area of the port; and
selectively providing electric power to one or more OLED elements to color and/or intensity tune the light output of the illumination source.

27. The method of claim 26, further comprising diffusing light emitted by said at least one OLED panel by disposing a diffuser across the port.
